(19) United States
(12) Patent Application Publication
(10) Pub. No.: US 2008/0175913 A1
(43) Pub. Date: Jul. 24, 2008

(54) Wood preservative compositions comprising isothiazolone-pyrethroids

(76) Inventors: Jun Zhang, Gertzville, NY (US); Richard J. Ziobro, Peachtree City, GA (US)

Correspondence Address: MILBANK, TWEED, HADLEY & MCCLOY LLP, INTERNATIONAL SQUARE BUILDING, 1850 K STRET, N.W., SUITE 1100, WASHINGTON, DC, 20006, US

(21) Appl. No.: 12/007,345

(22) Filed: Jan. 9, 2008

Related U.S. Application Data
(60) Provisional application No. 60/884,060, filed on Jan. 9, 2007.

(51) Int. Cl. A01N 25/12; A01N 43/80; A01N 59/20; A01N 59/16; A01P 7/04; B05D 1/36; B27K 3/00; A01P 3/00; A01N 59/14; A01N 59/22

(52) U.S. Cl. 424/489; 514/372; 424/630; 424/646; 424/657; 424/654; 424/650; 424/618; 424/641; 424/652; 424/655; 424/620; 424/633; 424/635; 428/541; 427/402

(57) ABSTRACT

The present invention relates to wood preservative compositions comprising an effective amount of a pyrethroid compound in combination with an isothiazolone compound, methods and processes for preserving wood using the wood preservative compositions of the invention, and wood comprising the wood preservative compositions of the invention.

This application claims priority to U.S. Provisional Application Ser. No. 60/884,060 that was filed on Jan. 9, 2007, which is hereby incorporated by reference in its entirety.

### FIELD OF THE INVENTION

The present invention relates to wood preservative compositions comprising an effective amount of a pyrethroid compound in combination with an isothiazolone compound. The invention further relates to methods and processes for preserving wood using the wood preservative compositions of the invention, and wood comprising the wood preservative compositions of the invention.

### BACKGROUND OF THE INVENTION

Wood and/or cellulose based products exposed in an outdoor environment are biodegradable, primarily through attack by microorganisms. As a result, they will decay, weaken in strength, and discolor. The microorganisms causing wood deterioration include brown rots such as Postia placenta, Gloeophyllum trabeum and Coniophora puteana, white rots such as Irpex lacteus and Trametes versicolor, dry rots such as Serpula lacrymans and Meruliporia incrassata and soft rots such as Cephalosporium, Acremonium and Chaetomium. Wood preservatives are well known for preserving wood and other cellulose-based materials, such as paper, particleboard, textiles, rope, etc., against organisms responsible for the deterioration of wood.

Isothiazolone compounds, such as, methylisothiazolinone; chloromethylisothiazolinone; 4,5-Dichloro-2-n-pctyl-3(2H)-1,2-benzisothiazolin-3-one; 2-octyl-3-isothiazolone; 5-chloro-2-methyl-4-isothiazoline-3-one are generally known to be effective biocides as wood preservation applications. Isothiazolone compounds are registered as pesticide for the use in wood preservation industry, and also used in the agricultural applications to protect plants, fruits, vegetables, cereal crops and sugar corps from fungal attack. U.S. Pat. No. 6,448,279 described a wood preservative composition containing an amine oxide and an isothiazolone compound. The amine oxides were found to improve the waterproofing properties and enhance the performance of isothiazolone compounds. U.S. Pat. No. 5,536,305 disclosed a wood preservative composition containing an isothiazolone compound and a surfactant and an organic solvent. U.S. Pat. No. 4,783,221 disclosed a wood preservative composition containing a metal compound and an isothiazolone compound.

Although the isothiazolone compounds are well known as fungicides, they have limited insecticidal activity. As a result, wood treated with these biocides is still subject to attack by wood-inhabiting insects, such as termites, beetles, ants, bees, wasps and so on. There has been an unmet need to produce organic based_preservatives systems that will prevent wood not only from the attack by decay fungi, but also from the attack by insects. This need is solved by the subject matter disclosed herein.

### SUMMARY OF THE INVENTION

Applicants have discovered that the use of pyrethroid-type insecticides as cobiocides with fungicidal isothiazolone compounds greatly improves the fungicidal activity of isothiazolone compounds. Examples of pyrethrins includes bifenthrin, permethrin and cypermethrin.

The present invention provides compositions and methods for preservation of wood against fungal and insect attack. The composition comprises 1) an isothiazolone compound and 2) a pyrethroid type insecticide.

Another embodiment of the present invention is a method for preserving a wood substrate by applying the composition to the wood substrate.

Provided in another embodiment of the invention is an article comprising a wood substrate to which has been applied the composition of the present invention.

Provided in yet another embodiment of the invention is a method of controlling fungi comprising applying an effective amount of the composition of the present invention to the fungi or the area on which the fungi grow.

The invention provides a wood preservative composition comprising an effective amount of a pyrethroid compound in combination with an isothiazolone compound. In a preferred embodiment, the pyrethroid compound of the wood preservative composition is selected from acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, or a combination thereof. In more preferred embodiment, the pyrethroid compound is bifenthrin, cypermethrin, permethrin, or a combination thereof.

In one embodiment, the isothiazolone compound of the wood preservative composition is selected from methyl isothiazolinone, 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 2-ethyl-4-isothiazoline-3-one, 4,5-dichloro-2-cyclohexyl-4-isothiazoline-3-one, 5-chloro-2-ethyl-4-isothiazoline-3-one, 2-octyl-3-isothiazolone, 5-chloro-2-t-octyl-4-isothiazoline-3-one, 1,2-benzisothiazoline-3-one, chloromethylisothiazolinone, 4,5-dichloro-2-n-octyl-3(2H)-isothiazolone, or a combination thereof. In more preferred embodiment, the isothiazolone compound is 5-chloro-2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, chloromethylisothiazolinone, 4,5-dichloro-2-n-octyl-3(2H)-isothiazolone, 1,2-benzisothiazolin-3-one, or a combination thereof.

In another embodiment, a wood preservative composition of the invention further comprises an inorganic biocide selected from the group consisting of a metal, a metal compound and a combinations thereof. In a preferred embodiment, the inorganic biocide of the word preservative composition of the invention is copper, cobalt, boron, cadmium, nickel, tin, silver, zinc, lead bismuth, chromium and arsenic and compounds thereof. In more preferred embodiment, the copper compound of the inorganic biocide of the word preservative composition is selected from the group consisting of copper hydroxide, cupric oxide, cuprous oxide, copper carbonate, basic copper carbonate, copper oxychloride, copper 8-hydroxyquinolate, copper dimethyldithiocarbamate, copper omadine and copper borate.

In a preferred embodiment, inorganic biocide of the wood preservative composition is a micronized particle.

In another embodiment, a wood preservative composition of the invention further comprises one or more organic biocides selected from a fungicide, insecticide, algaecide, moldicide and bactericide. In a preferred embodiment, the organic biocide is a micronized particle.

In another embodiment, the wood preservative composition of the invention further comprises emulsifier, dispersant, insecticide, fungicide, or combination thereof.

In another aspect, the invention provides a method for preserving wood comprising the steps of contacting a wood preservative composition with wood, wherein the wood preservative composition comprises a pyrethroid compound in combination with an isothiazolone compound.

The invention also provides wood comprising an effective amount of a pyrethroid compound in combination with an isothiazolone compound.

In another aspect, the wood of the invention is resistant to fungi and insect attack.

The invention further provides a process for preserving wood, said process comprising the steps of contacting wood with a first wood preservative component comprising a pyrethroid compound, a second wood preservative component comprising an isothiazolone compound, either sequentially, simultaneously, or in combination.

In another aspect, the invention provides use of a wood preservative composition of the invention to control the growth of fungi.

Provided is also a method of controlling the growth of fungi comprising applying an effective amount of a composition of the invention to the fungi or the area on which the fungi grow.

In another aspect, the invention provides use of a wood preservative composition of the invention to control insect attack.

The invention also provides a method of controlling insect attack comprising applying an effective amount of a wood preservative composition of the invention to wood.

### BRIEF DESCRIPTION OF THE DRAWINGS

FIG. 1 illustrates the border pit structure for coniferous woods.

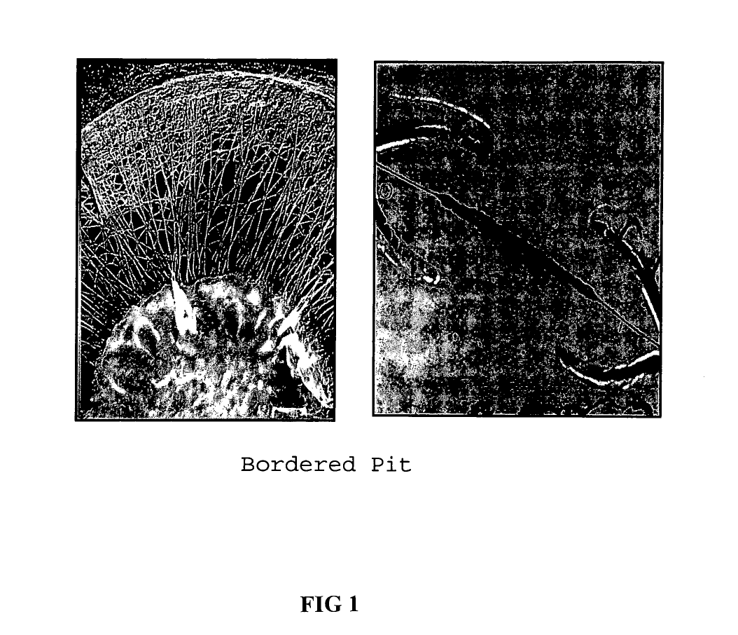

### DETAILED DESCRIPTION OF THE INVENTION

Disclosed herein is an organic composition and method for use thereof in treatment of cellulosic material, more particularly wood. The composition comprises an isothiazolone compound, and a pyrethroid insecticide. The composition imparts to the treated wood resistance to both fungi and insects. Surprisingly, the fungicidal activity of isothiazolone compounds used in combination with pyrethroid-type insecticide compounds is substantially greater than the fungicidal activities of isothiazolone compounds when used alone. This is all the more unexpected in that pyrethroid insecticides, such as bifenthrin, cypermethrin, or permethrin, generally do not have fungicidal activity against brown rots or white rots.

The compositions of the present invention have a broad spectrum of bio-efficacy against wood decay fungi, including types against which isothiazolone compounds are known to be effective, such as, for example, brown rot fungi, white rot fungi, and soft rot fungi. Non-limiting examples of brown rot fungi include: Coniophora puteana, Serpula lacrymans, Antrodia vaillantii, Gloeophyllum trabeum, Gleoeophyllum sepiarium, Lentinum lepideus, Oligoporus placenta, Meruliporia incrassate, Daedalea quercina, and Postia placenta. Non-limiting examples of white rot fungi include: Trametes versicolor, Phanerochaete chrysosporium, Pleurotus ostreatus, Schizophyllum commune, Irpex lacteus. Some non-limited examples of white rot fungi are Chaetomium globosum, Lecythophora hoffmannii, Monodictys putredinis, Humicola alopallonella, Cephalosporium, Acremonium, and Chaetomium.

The compositions of the present invention are also effective against a broad range of insects and marine borer, including types against which pyrethroid compounds are known to be effective, such as, for example, termites, beetles, and wood-boring insects. Non-limiting examples of termites include drywood termites such as Cryptotermes and Kalotermes, and dampwood termites such as Zootermopsis, subterranean termites such as Coptotermes, Mastotermes, Reticulitermes, Schedorhinotermes, Microcerotermes, Microtermes, and Nasutitermes. Non-limiting examples of beetles include those in families such as, for example, Anoniidae, Bostrychidae, Cerambycidae, Scolytidae, Curculionidae, Lymexylonidae, and Buprestidae.

The compositions of the present invention are useful as wood preservatives for protecting wood and/or wood based products, such as, for example, lumber, timbers, particle board, plywood, laminated veneer lumber (LVL), oriented strained board (OSB), etc. from decaying, discoloring, staining/molding, and weakening in its strength. The compositions are also useful in protecting cellulose based products, such as textile fibers, wood pulp, wool and natural fiber, from fungi and insect attacks.

The compositions of the present invention can also be used for supplemental or remedial treatment of wood in service, such as utility poles and railroad ties. When used as remedial preservative purpose, the compositions can be in the form of a paste- or grease-type of formulations, if desired, such that the formulation has an adhesive nature and is easy to apply to a desired location. In this embodiment, the composition of the present invention can be applied to the wood surface through external coating treatment.

The present composition of the invention further comprises an inorganic biocide selected from the group consisting of a metal, a metal compound and a combinations thereof. Preferably, the inorganic biocide is copper, cobalt, boron, cadmium, nickel, tin, silver, zinc, lead bismuth, chromium and arsenic and compounds thereof. More preferably, the copper compound is selected from the group consisting of copper hydroxide, cupric oxide, cuprous oxide, copper carbonate, basic copper carbonate, copper oxychloride, copper 8-hydroxyquinolate, copper dimethyldithiocarbamate, copper omadine and copper borate.

Fungicidal compounds which in the present invention include isothiazolone compounds. Typical examples of isothiazolone compounds include but not limited to: methylisothiazolinone; 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 2-ethyl-4-isothiazoline-3-one, 4,5-dichloro-2-cyclohexyl-4-isothiazoline-3-one, 5-chloro-2-ethyl-4-isothiazoline-3-one, 2-octyl-3-isothiazolone, 5-chloro-2-t-octyl-4-isothiazoline-3-one, 1,2-benzisothiazoline-3-one, preferably 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, etc., more preferably 5-chloro-2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, chloromethylisothiazolinone; 4,5-Dichloro-2-n-octyl-3(2H)-isothiazolone; 1,2-benzisothiazolin-3-one.

The pyrethroid compounds include: acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen. Preferred pyrethroid insecticides are bifenthrin, cypermethrin, and permethrin.

The preservative compositions of the present invention can be used in the preservation of wood in a variety of ways. For example as a solution in organic solvents, an emulsion in water by emulsifying the compounds with the aid of emulsifiers, or as dispersion in water by dispersing through homogenizer or high speed agitation or through milling/grinding process or any other chemical and physical means. The fungicide and insecticide can be simultaneously or successively added to water in the presence of an emulsifier or a dispersant, followed by mixing under stirring or by grinding in a media mill. Individual concentrates of the isothiazolone or pyrethroid can be also prepared in the forms of solution, emulsion or dispersion, and then the individual concentrates of isothiazolone or pyrethroid can be mixed together and diluted to a working solution for treating wood.

Non-limited examples of solvents used for dissolving isothiazolone and pyrethroid compounds include dichloromethane, hexane, toluene, alcohols such as methanol, ethanol, and 2-propanol, glycols such as ethylene glycol and propylene glycol, ethers, esters, poly-glycols, poly-ethers, amides, methylene chloride, acetone, chloroform, N,N-dimethyl octanamide, N,N-dimethyl decanamide, N-methyl 2-pyrrolidone, n-(noctyl)-2-pyrrolidone, and combinations of the above. Typical dispersants include acrylic copolymers, aqueous solution of copolymers with pigment affinity groups, modified polyacrylate, acrylic polymer emulsions, modified lignin and the like.

Emulsifiers can be anionic, cationic, or nonionic or the combinations. Examples of emulsifiers include, but are not limited to, ethyoxylated alkylphenols or amines or amides or aryl phenols or fatty esters, fatty acids and derivatives, ethoxylated alcohols and derivatives, sulfonated amine or amides and derivatives, carboxylated alcohol or alkylphenol ethoxylates and derivatives, glycol ethers or esters. Additional examples of emulsifiers can be found in McCutcheon's Emulsifiers and Detergents, 2005, the contents of which are incorporated herein by reference.

The preservative compositions of the present invention can be used in the organic media where organic solvents function as carrier. For example, the composition can be used in Light Organic Solvent Preservation (LOSP), where white spirits are used as the solvent carrier. Examples of other organic solvent carrier include, but not limited to, mineral spirits, hydrocarbon solvents as described in American Wood Preservers' Association Standard P9-03, toluene, coconut oil, corn oil, soybean oil, cottonseed oil, linseed oil, peanut oil, and palm oil. The solvent treatment can generally help improve the dimensional stabilization of wood, and hence reduce checking, warping or twisting. In addition, some organic solvents also help improve the bio-efficacy of the preservative systems.

The fungicide and insecticide can also dissolved in organic solvents. Non-limited organic solvents include hydrocarbon compounds such as benzene, toluene and their derivatives, alcohols such as methanol, ethanol, ethylene glycol, propylene glycol, polyethylene glycol and their derivatives, esters such as ethyl acetate and their derivatives, ketones, dimethylsulfoxide, etc.

It should be noted that the present invention is not limited biocides dissolved in oil or water, as it is expected that particulate or micronized particulate biocides (such as, for example aqueous dispersions) will effectively preserve wood as well.

The micronized particles can be obtained by grinding the biocidal compounds using a commercially available grinding mill. Particulate compound can be wet or dry dispersed in a liquid prior to grinding. Other means of obtaining micronized particles include chemical or physical or mechanical means.

A preferred method is by grinding. One exemplary method involves the formation of a slurry comprising a dispersant, a carrier, and a powdered biocide having a particle size in the range of from 1 micron to 500 microns, and optionally, a defoamer. The slurry is transferred to a grinding mill which is prefilled with a grinding media having a size from 0.05 mm to 5 mm, and preferably between 0.1 and 1 mm. The media can be one or more of many commercially available types, including but not limited to steel shots, carbon steel shots, stannous steel shots, chrome steel shots, ceramic (for example, alumina-containing); zirconium-based, such as zirconia, zirconium silicate, zirconium oxide; stabilized zirconia such as stabilized ytz-stabilized zirconia, ceria-stabilized zirconia, stabilized magnesium oxide, stabilized aluminum oxide, etc.

The medium preferably occupies 50% to 99% of the grinding chamber volume, with 75 to 95% preferred, and 80 to 90% more preferred. The bulk density of the grinding media is preferably in the range of from 0.5 kg/l to 10 kg/l, and more preferably in the range of from 2 to 5 kg/l. Agitation speed, which can vary with the size of the grinder, is generally in the range of from 1 to 5000 rpm, but can be higher or lower. Lab and commercial grinders generally run at different speeds. A set up which involves a transfer pump which repeatedly cycles the slurry between the mill and a storage tank during grinding is convenient. The transfer pump speed varies from 1 to 500 rpm, and the speeds for lab and commercial grinders can be different. During grinding, defoamer can be added if foaming is observed. During grinding, particle size distribution can be analyzed, and once particle size is within the desired specification, grinding is stopped.

The particles are generally dispersed in dispersants which can include standard dispersants known in the art. The dispersant can be cationic, non-ionic and anionic, and the preferred dispersants are either non-ionic or cationic. Examples of surfactants which can be used in the compositions and methods of the present invention include acrylic copolymers, an aqueous solution of copolymers with pigment affinity groups, polycarboxylate ether, modified polyacrylate, acrylic polymer emulsions, modified acrylic polymers, poly carboxylic acid polymers and their salts, modified poly carboxylic acid polymers and their salts, fatty acid modified polyester, aliphatic polyether or modified aliphatic polyether, polyetherphosphate, modified maleic anhydride/styrene copolymer, lignin and the like.

If desired, a wetting agent can be used in the preparation of the compositions of the present invention. For metal or metal compound biocides, the level of wetting agent is in the range of from about 0.1 to 180% of the weight of the biocide compounds, with a preferred range of 1 to 80%, a more preferred range of 5 to 60%, and a most preferred range of 10 to 30%. For organic biocides, such as, for example, isothiazolone or pyrethroid, the level of wetting agent is in the range of from about 1 to 200% of the weight of the biocide compounds, with a preferred range of 5 to 100%, a more preferred range of 10 to 80%, and a most preferred range of 30 to 70%.

The degree of penetration and uniformity of distribution of the particles into the wood cellular structure is related to the prevalence of particles with relatively large particle size. If the biocide source used in formulating the dispersion formulation disclosed herein has a particle size in excess of 25 microns, the particles may be filtered by the surface of the wood and thus may not be uniformly distributed within the cell and cell wall. Furthermore, particles with long axes greater than 25 micron may clog tracheids and inhibit the uptake of additional particles. The primary entry and movement of fluids through wood tissue occurs primarily through the tracheids and border pits. Tracheids generally have a diameter of very roughly thirty microns. Fluids are transferred between wood cells by means of border pits.

The overall diameter of the border pit chambers typically varies from a several microns up to thirty microns, while the diameter of the pit openings (via the microfibrils) typically varies from several hundredths of a micron to several microns. The sole FIGURE depicts the border pit structure for coniferous woods. When wood is treated with micronized preservative formulation, if the particle size of the micronized preservative is less than the diameter of the pit openings, a complete penetration and a uniform distribution of micronized preservative in wood is expected.

It should be understood that although the compositions disclosed herein contain micronized particles, they can contain particles which are not micronized, i.e., with diameters which are outside the range of from 0.001 to 25 microns. If a particulate organic biocide is used, the organic biocide particle sizes should correspond to a distribution in which the largest particles do not appreciably inhibit the penetration of the particulate inorganic and organic components. If more than one micronized component is used, it is thus desirable that 98% (by weight) of the total number of particles in the composition have diameters which are less than 25 microns, and preferably less than 10 microns more preferably, less than 5 micron and more preferably, less than 1 micron.

Particle size distributions which conform to the above size distribution parameters can be prepared by methods known in the art. For example, particles can be obtained by grinding the mixture of biocide and dispersant. The particle size distribution can be controlled by the ratio of dispersant to biocide, grinding times, the size of grinding media, etc. It is within the ability of one skilled in the art to adjust the aforementioned parameters in order to obtain a suitable distribution, such as a non-clogging particle distribution in which greater than about 3 weight percent of the particles have a diameter of 0.5 microns.

The weight ratio of isothiazolone compounds to pyrethroid compounds broadly ranges from about 1000:1 to about 0.001:1 and preferably ranges from about 50:1 to about 0.1:1, and more preferably ranges from 10:1 to 1:1.

According to one embodiment of the invention, the composition in concentrated form contains broadly from about 0.5 to about 60%, preferably from about 1 to about 50%, and more preferably from about 10 to about 40% by weight of combined isothiazolone compounds and pyrethroid based upon 100% weight of total composition. Individual concentrates of isothiazolone or pyrethroid can also be prepared and then mixed together with water to the treating fluids for wood treatment.

Non-biocidal products such as water repellants, colorants, emulsifying agents, dispersants, stabilizers, UV inhibitors, pigments, wax emulsions, acylate polymers, and the like may also be added to the system disclosed herein to further enhance the performance of the system or the appearance and performance of the resulting treated products.

The present invention also provides a method for preservation of wood. In one embodiment, the method comprises the steps of treating wood with a composition (treating fluid) comprising an isothiazolone compound and a pyrethroid compound. The treating fluid may be applied to wood by impregnation, dipping, soaking, spraying, brushing, or any other means well known in the art. When used as remedial preservative purpose, the compositions can be applied to the wood surface through external coating treatment. In a preferred embodiment, vacuum and/or pressure techniques are used to impregnate the wood in accord with this invention including the standard processes, such as the “Empty Cell” process, the “Modified Full Cell” process and the “Full Cell” process, and any other vacuum and/or pressure processes which are well known to those skilled in the art.

The standard processes are defined as described in AWPA Standard C1-03 “All Timber Products—Preservative Treatment by Pressure Processes”. In the “Empty Cell” process, prior to the introduction of preservative, materials are subjected to atmospheric air pressure (Lowry) or to higher air pressures (Rueping) of the necessary intensity and duration. In the “Modified Full Cell”, prior to introduction of preservative, materials are subjected to a vacuum of less than 77 kPa (22 inch Hg) (sea level equivalent). A final vacuum of not less than 77 kPa (22 inch Hg) (sea level equivalent) shall be used. In the “Full Cell Process”, prior to introduction of preservative or during any period of condition prior to treatment, materials are subjected to a vacuum of not less than 77 kPa (22 inch Hg). A final vacuum of not less than 77 kPa (22 inch Hg) is used.

### EXAMPLES

The following examples are provided to further describe certain embodiments of the invention but are in no way meant to limit the scope of the invention.
4,5-dichloro-2-n-octyl-4-isothiazoline-3-one;
5-chloro-2-methyl-4-isothiazoline-3-one;
2-methyl-4-isothiazoline-3-one
1,2-benzisothiazoline-3-one
2-n-octyl-4-isothiazoline-3-one

### Example 1

An organic preservative concentrate containing 5.0 wt % of 4,5-dichloro-2-n-octyl-4-isothiazoline-3-one and 0.5 wt % bifenthrin is obtained by dissolving 10.0 grams of 4,5-dichloro-2-n-octyl-4-isothiazoline-3-one and 1.0 gram of bifenthrin in 189.0 grams of xylene. The resulting concentrates can be mixed with other organic solvents, such as glycols, toluene or spirits, to make treating solutions to treat wood.

### Example 2

50.0 g 4,5-dichloro-2-n-octyl-4-isothiazoline-3-one and 10.0 g bifenthrin were dissolved in 125.0 g of N,N-dimethyl octanamide and 50.0 g N,N-dimethyl decanamide. The solution is added to a beaker containing 200 g of water and 200 g of commercially available emulsifiers. The mixture was agitated with a high speed homogenizer for 30 minutes. A micro-emulsion containing 7.87 wt % 4,5-dichloro-2-n-octyl-1-4-isothiazoline-3-one and 1.57 wt % bifenthrin is obtained. The micro-emulsion can be mixed with water to make the work solution for treating wood samples.

### Example 3

20.0 g of 5-chloro-2-methyl-4-isothiazoline-3-one, 50.0 g of 2-methyl-4-isothiazoline-3-one and 14.0 g of bifenthrin are added to a beaker containing 916.0 g of Nmethyl-2-pyrrolidone. The mixture was agitated for about 30 minutes, and a clear solution was obtained. The target concentration of 5-chloro-2-methyl-4-isothiazoline-3-one, 2-methyl-4-isothiazoline-3-one and bifenthrin by weight was 2.0%, 5.0% and 1.4%, respectively. The resulting concentrates can be mixed with other organic solvents, such as methanol, ethanol, toluene or spirits, to make treating solutions to treat wood.

### Example 4

50.0 g of 2-n-octyl-4-isothiazoline-3-one and 10.0 g of bifenthrin are added to a beaker containing 140.0 g of N—(N-octyl)-2-pyrrolidone. The mixture was agitated for about 30 minutes, and a clear solution was obtained. The target concentration of 2-noctyl-4-isothiazoline-3-one and bifenthrin by weight was 25.0% and 5.0%, respectively. The resulting concentrates can be mixed with other organic solvents, such as toluene or spirits, to make treating solutions.

### Example 5

The concentrate prepared in Example 4 is added to a beaker containing 200 g of water and 200 g of commercially available emulsifiers. The mixture was agitated with a high speed homogenizer for 10 minutes. A micro-emulsion containing 8.33 wt % 2-noctyl-4-isothiazoline-3-one and 1.67 wt % bifenthrin was obtained. The micro-emulsion can be mixed with water indefinitely to make the work solution for treating wood samples.

### Example 6

50.0 g of 1,2-benzisothiazoline-3-one and 10.0 g of cypermethrin were dissolved in 225.0 g of toluene. The solution was added to a beaker containing 225 g of water and 200 g of commercially available emulsifiers. The mixture was agitated with a high speed homogenizer for 10 minutes. A micro-emulsion containing 7.04 wt % 1,2-benzisothiazoline-3-one and 1.41 wt % cypermethrin was obtained. The micro-emulsion can be mixed with water to make the work solution for treating wood samples.

### Example 7

25.0 g of 1,2-benzisothiazoline-3-one, 25.0 g of 2-n-octyl-4-isothiazoline-3-one and 10.0 g of bifenthrin are dissolved in 240 g of N—(N-octyl)-2-pyrrolidone, and then 200 g of commercially available emulsifiers were added to the solution. The mixture is agitated with a high speed homogenizer for 10 minutes, and a clear solution containing 5.0 wt % 1,2-benzisothiazoline-3-one, 5.0 wt % 2-n-octyl-4-isothiazoline-3-one and 2.0 wt % bifenthrin. The resulting solution can be mixed with water to make the work solution for treating wood samples.

### Example 8

1000 grams of 4,5-dichloro-2-n-octyl-4-isothiazoline-3-one and 100 grams of bifenthrin are mixed with a mixture of 2500 grams water and 300 grams dispersant. The mixture is mechanically mixed for about 20 minutes and then added to a grinding mill. The mixture is ground for about 120 minutes and a stable dispersion is obtained with a mean particle size of 0.25 microns and 100 wt % particles less than one micrometers. The concentration of 4,5-dichloro-2-n-octyl-4-isothiazoline-3-one and bifenthrin in the finished product is 25.6 wt % and 2.56 wt %, respectively.

### Example 9

Preservative treating solutions are prepared by the mixing the concentrates in Example 1 with toluene. The treating solutions are then used to treat southern pine measuring 1.5″×3.5″×10″ using the full-cell process wherein the wood is initially placed under a vacuum of 30″ Hg for 30 minutes, followed by the addition of the treating solution. The system is then pressurized for 30 minutes at 100 psi. A final vacuum of 28″ Hg for 30 minutes is applied to the wood to remove residual liquid. The treated wood is resistant to fungal and insect attack.

### Example 10

Preservative treating solutions were prepared by the mixing the concentrates in Example 3 with toluene. The treating solutions are then used to treat southern pine measuring 1.5″×3.5″×10″ using the full-cell process wherein the wood is initially placed under a vacuum of 30″ Hg for 30 minutes, followed by the addition of the treating solution. The system is then pressurized for 30 minutes at 100 psi. A final vacuum of 28″ Hg for 30 minutes is applied to the wood to remove residual liquid. The wood is found to be resistant to fungal and insect attack.

### Example 11

A preservative treating formulation is prepared by adding 0.15 kg of the emulsion concentrate from Example 2 to 11.6 kg of water. This fluid is allowed to mix until a homogenous fluid is prepared. This fluid was used to treat southern pine samples measuring at 1.5″×5.5″×48″ by the full-cell process. The weight of the treated samples double and demonstrate a uniform distribution of particles throughout the wood cells and is found to be resistant to decay and insect attack.

### Example 12

A preservative treating composition is prepared by adding 0.50 kg of dispersion from Example 8 to 63.5 kg of water. The resulting fluid contains about 0.20% 4,5-dichloro-2-n-oetyl-4-sothiazoline-3-one and 0.02% bifenthrin. This fluid is then used to treat southern pine measuring 1.5″×5.5″×48″ using the full-cell process wherein the wood is initially placed under a vacuum of 30″ Hg for 30 minutes, followed by the addition of the treating solution. The system is then pressurized for 30 minutes at 100 psi. A final vacuum of 28″ Hg for 30 minutes is applied to the wood to remove residual liquid. The wood is found to contain a uniform distribution of preservative particle throughout the cross sections and is resistant to fungal and insect attack.

What is claimed is:

1. A wood preservative composition comprising an effective amount of a pyrethroid compound in combination with an isothiazolone compound.

2. The composition of claim 1, wherein the pyrethroid compound is selected from acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, or a combination thereof.

3. The composition of claim 2, wherein the pyrethroid compound is bifenthrin, cypermethrin, permethrin, or a combination thereof.

4. The composition of claim 1, wherein the isothiazolone compound is selected from methylisothiazolinone, 5-chloro-2-methyl-4-isothiazoline-3-one, 2-methyl-4-isothiazoline-3-one, 2-n-octyl-4-isothiazoline-3-one, 4,5-dichloro-2-n-octyl-4-isothiazoline-3-one, 2-ethyl-4-isothiazoline-3-one, 4,5-dichloro-2-cyclohexyl-4-isothiazoline-3-one, 5-chloro-2-ethyl-4-isothiazoline-3-one, 2-octyl-3-isothiazolone, 5-chloro-2-t-octyl-4-isothiazoline-3-one, 1,2-benzisothiazoline-3-one, chloromethylisothiazolinone, 4,5-dichloro-2-n-octyl-3(2H)-isothiazolone, or a combination thereof.

5. The composition of claim 4, wherein the isothiazolone compound is 5-chloro-2-methyl-4-isothiazoline-3-one, 2-n-octyl-4-isothiazoline-3-one, 4,5-dichloro-2-n-octyl-4-isothiazoline-3-one, 1,2-benzisothiazoline-3-one, chloromethylisothiazolinone, 4,5-dichloro-2-n-octyl-3(2H)-isothiazolone, 1,2-benzisothiazolin-3-one, or a combination thereof.

6. The composition of claim 1, further comprising an inorganic biocide selected from the group consisting of a metal, a metal compound and a combinations thereof.

7. The composition of claim 6, wherein the inorganic biocide is copper, cobalt, boron, cadmium, nickel, tin, silver, zinc, lead bismuth, chromium and arsenic and compounds thereof.

8. The composition of claim 7, wherein the copper compound is selected from the group consisting of copper hydroxide, cupric oxide, cuprous oxide, copper carbonate, basic copper carbonate, copper oxychloride, copper 8-hydroxyquinolate, copper dimethyldithiocarbamate, copper omadine and copper borate.

9. The composition of claim 6, wherein the inorganic biocide is a micronized particle.

10. The composition of claim 1, further comprising one or more organic biocides selected from a fungicide, insecticide, algaecide, moldicide and bactericide.

11. The composition of claim 10, wherein the organic biocide is a micronized particle.

12. The composition of claim 1, further comprising emulsifier, dispersant, insecticide, fungicide, or combination thereof.

13. A method for preserving wood comprising the steps of contacting a wood preservative composition with wood, wherein the wood preservative composition comprises a pyrethroid compound in combination with an isothiazolone compound.

14. Wood comprising an effective amount of a pyrethroid compound in combination with an isothiazolone compound.

15. Wood of claim 14, wherein the wood is resistant to fungi and insect attack.

16. A process for preserving wood, said process comprising the steps of contacting wood with a first wood preservative component comprising a pyrethroid compound, a second wood preservative component comprising an isothiazolone compound, either sequentially, simultaneously, or in combination.

17. A method of controlling the growth of fungi comprising applying an effective amount of a composition of any one of claim 1 to the fungi or the area on which the fungi grow.

18. A method of controlling insect attack comprising applying an effective amount of a composition of any one of claim 1 to wood.
